(19) United States
(12) Patent Application Publication
(10) Pub. No.: US 2026/0020051 A1
(43) Pub. Date: Jan. 15, 2026

(54) INFORMATION SHARING FOR HANDLING COEX EVENTS

(71) Applicant: Samsung Electronics Co., Ltd., Suwon-si (KR)

(72) Inventors: Rubayet Shafin, Allen, TX (US); Boon Loong Ng, Plano, TX (US); Peshal Nayak, Plano, TX (US); Vishnu Vardhan Ratnam, Plano, TX (US); Yue Qi, Plano, TX (US); Bilal Sadiq, Plano, TX (US)

(21) Appl. No.: 19/253,540

(22) Filed: Jun. 27, 2025

Related U.S. Application Data
(60) Provisional application No. 63/670,612, filed on Jul. 12, 2024.

(51) Int. Cl. H04W 74/04; H04W 74/00; H04W 74/08; H04W 74/0816

(52) U.S. Cl. CPC H04W 74/04; H04W 74/002; H04W 74/0816; H04W 74/0875

(57) ABSTRACT

Disclosed is a mechanism for an AP to request for information related to an unavailability schedule that has been set up with a STA. The information may enable the AP to inform or recommend the STA to change the unavailability schedule. A STA may establish an unavailability schedule with an AP. The STA is unavailable to communicate with the AP based on the unavailability schedule. The STA may receive from the AP a request for information related to the unavailability schedule. The request may solicit information on the traffic of a coexistence event between the STA and a second STA. The STA may transmit to the AP a response that provides characteristics of the unavailability schedule, such as the traffic of the coexistence event, based on the request. The STA may communicate with the AP during an availability interval that is non-overlapping with the unavailability schedule.

### CROSS-REFERENCE TO RELATED APPLICATIONS

This application claims the benefit of priority from U.S. Provisional Application No. 63/670,612 entitled “INFORMATION SHARING FOR HANDLING COEX EVENTS,” filed on Jul. 12, 2024, the disclosure of which is incorporated herein by reference in its entirety.

### TECHNICAL FIELD

This disclosure relates generally to a wireless communication system, and more particularly to, but not limited to, mechanisms for a device to share and report information about an unavailability schedule with a peer device in wireless communication systems such as when the unavailability schedule due to a coexistence event.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

An aspect of the disclosure provides a first STA in a wireless network. The first STA includes a memory and a processor coupled to the memory. The processor is configured to cause the first STA to establish an unavailability schedule with an AP. The first STA is unavailable to communicate with the AP based on the unavailability schedule. The processor is also configured to cause the first STA to receive, from the AP, a request for information related to the unavailability schedule. The processor is further configured to cause the first STA to transmit, to the AP, a response that provides characteristics of the unavailability schedule based on the request. The processor is further configured to cause the first STA to communicate with the AP during an availability interval that is non-overlapping with the unavailability schedule.

In one embodiment, the unavailability schedule is due to a coexistence event for peer-to-peer (P2P) communication between the first STA and a second STA. When the first STA receives the request for information related to the unavailability schedule, the processor is configured to cause the first STA to receive, from the AP, a coexistence information request frame that solicits information on traffic of the coexistence event.

In one embodiment, the information on the traffic of the coexistence event includes one or more of: a traffic identifier of the traffic for the P2P communication; a user priority of the traffic for the P2P communication; a delay bound of the traffic for the P2P communication; a minimum service interval of the traffic for the P2P communication; a maximum service interval of the traffic for the P2P communication; a service period of the traffic for the P2P communication; a service interval of the traffic for the P2P communication; or an identifier of the second STA.

In one embodiment, the unavailability schedule is due to a coexistence event for P2P communication between the first STA and a second STA. When the first STA transmits the response that provides characteristics of the unavailability schedule, the processor is configured to cause the first STA to transmit, to the AP, a coexistence information response frame that provides information on traffic of the coexistence event.

In one embodiment, the unavailability schedule is due to a coexistence event for P2P communication between the first STA and a second STA. When the first STA receives the request for information related to the unavailability schedule, the processor is configured to cause the first STA to receive, from the AP, an initial control frame that solicits information on traffic of the coexistence event. The initial control frame initiates a frame exchange sequence between the first STA and the AP.

In one embodiment, when the first STA transmits the response that provides characteristics of the unavailability schedule, the processor is configured to cause the first STA to transmit, to the AP, an initial control response frame that provides information on the traffic for the P2P communication of the coexistence event in response to the initial control frame.

In one embodiment, the processor is further configured to cause the first STA to receive, from the AP, a recommendation frame that recommends a change to the unavailability schedule. The processor is also configured to cause the first STA to modify the unavailability schedule based on the recommendation frame.

In one embodiment, the unavailability schedule is due to a coexistence event for P2P communication between the first STA and a second STA. The characteristics of the unavailability schedule provided by the response includes one or more of: a frequency band for the P2P communication; a frequency channel for the P2P communication; a length of the P2P communication; or a time of the P2P communication.

An aspect of the disclosure provides an AP in a wireless network. The AP includes a memory and a processor coupled to the memory. The processor is configured to cause the AP to establish an unavailability schedule agreement with a STA. The AP is unavailable to communicate with the first STA based on the unavailability schedule. The processor is also configured to cause the AP to transmit, to the first STA, a request for information related to the unavailability schedule. The processor is further configured to cause the AP to receive, from the first STA, a response that provides characteristics of the unavailability schedule based on the request. The processor further configured to cause the AP to communicate with the first STA during an availability interval that is non-overlapping with the unavailability schedule.

In one embodiment, the unavailability schedule is due to a coexistence event for P2P communication between the first STA and a second STA. When the AP transmits the request for information related to the unavailability schedule, the processor is configured to cause the AP to transmit, to the first STA, a coexistence information request frame that solicits information on traffic of the coexistence event.

In one embodiment, the information on the traffic of the coexistence event includes one or more of: a traffic identifier of the traffic for the P2P communication; a user priority of the traffic for the P2P communication; a delay bound of the traffic for the P2P communication; a minimum service interval of the traffic for the P2P communication; a maximum service interval of the traffic for the P2P communication; a service period of the traffic for the P2P communication; a service interval of the traffic for the P2P communication; or an identifier of the second STA.

In one embodiment, the unavailability schedule is due to a coexistence event for P2P communication between the first STA and a second STA. When the AP receives the response that provides characteristics of the unavailability schedule, the processor is configured to cause the AP to receive, from the first STA, a coexistence information response frame that provides information on traffic of the coexistence event.

In one embodiment, the unavailability schedule is due to a coexistence event for P2P communication between the first STA and a second STA. When the AP transmits the request for information related to the unavailability schedule, the processor is configured to cause the AP to transmit, to the first STA, an initial control frame that solicits information on traffic of the coexistence event. The initial control frame initiates a frame exchange sequence between the first STA and the AP.

In one embodiment, when the AP receives the response that provides characteristics of the unavailability schedule, the processor is configured to cause the AP to receive, from the first STA, an initial control response frame that provides information on the traffic for the P2P communication of the coexistence event in response to the initial control frame.

The processor is further configured to cause the first AP to transmit, to the first STA, a recommendation frame that recommends a change to the unavailability schedule in response to the characteristics of the unavailability schedule received from the first STA.

In one embodiment, the unavailability schedule is due to a coexistence event for P2P communication between the first STA and a second STA. The characteristics of the unavailability schedule provided by the response includes one or more of: a frequency band for the P2P communication; a frequency channel for the P2P communication; a length of the P2P communication; or a time of the P2P communication.

An aspect of the disclosure provides a method performed by a first STA in a wireless network. The method includes the first STA establishing an unavailability schedule with an AP, the first STA being unavailable to communicate with the AP based on the unavailability schedule. The method also includes the first STA receiving, from the AP, a request for information related to the unavailability schedule. The method further includes first STA transmitting, to the AP, a response that provides characteristics of the unavailability schedule based on the request. The method further includes the first STA communicating with the AP during an availability interval that is non-overlapping with the unavailability schedule.

In one embodiment, the unavailability schedule is due to a coexistence event for P2P communication between the first STA and a second STA. For the first STA receiving the request for information related to the unavailability schedule, the method includes the first STA receiving, from the AP, a coexistence information request frame that solicits information on traffic of the coex event. For the first STA transmitting, to the AP, the response that provides characteristics of the unavailability schedule, the method includes the first STA transmitting, to the AP, a coexistence information response frame that provides the information on the traffic of the coexistence event. The information on the traffic of the coexistence event includes one or more of: a traffic identifier of the traffic for the P2P communication; a user priority of the traffic for the P2P communication; a delay bound of the traffic for the P2P communication; a minimum service interval of the traffic for the P2P communication; a maximum service interval of the traffic for the P2P communication; a service period of the traffic for the P2P communication; a service interval of the traffic for the P2P communication; or an identifier of the second STA.

### BRIEF DESCRIPTION OF THE DRAWINGS

FIG. 1 shows an example of a wireless network in accordance with an embodiment.

FIG. 2A shows an example of AP in accordance with an embodiment.

FIG. 2B shows an example of STA in accordance with an embodiment.

FIG. 3 shows an example of multi-link communication operation in accordance with an embodiment.

FIG. 4 shows a network where infrastructure traffic and non-infrastructure traffic coexist in accordance with one embodiment.

FIG. 5 shows a STA1 indicating to its associated AP time periods during which the STA1 will be unavailable for frame exchange with the AP due to scheduled peer-to-peer (P2P) communication with a STA2 in accordance with one embodiment.

FIG. 6 shows the STA1 indicating to its associated AP time periods during which STA1 will be unavailable for frame exchange with the AP due to scheduled P2P co-existence event with the STA2 in accordance with one embodiment.

FIG. 7 shows a STA1 setting up an availability/unavailability schedule with its associated AP1 due to an upcoming coex event in one scenario.

FIG. 8 shows STA1 missing high-priority traffic from AP1 due to unavailability (coex event) of STA1 520 in one scenario.

FIG. 9 shows a STA1 indicating to its associated AP the nature of the coex event due to a Bluetooth-related operation in accordance with one embodiment.

FIG. 10 shows a STA1 indicating to its associated AP the nature of the coex event due to a P2P Wi-Fi coex event when the P2P communication is expected to happen on the same band/channel as the communication between STA1 and AP in accordance with one embodiment.

FIG. 11 shows a STA1 indicating to its associated AP the nature of the coex event due to a P2P Wi-Fi coex event when the P2P communication is expected to happen on a different band/channel from those used between STA1 and AP in accordance with one embodiment.

FIG. 12 shows a STA1 sharing information of a coex event with an AP1 using the Coex Information Request and Coex Information Response frame exchange in accordance with one embodiment.

FIG. 13 shows a STA1 sharing information of a coex event with an AP1 using the initial control and initial response frame exchange in accordance with one embodiment.

FIG. 14 shows an AP1 recommending to a STA1 to revise the timing of the unavailability SP in accordance with one embodiment.

FIG. 15 shows a flow diagram of a method 1500 of a STA sharing information on an unavailability schedule with an AP in accordance with one embodiment.

FIG. 16 shows a flow diagram of a method 1600 of an AP receiving information on an unavailability schedule from a STA in accordance with one embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard.

However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax etc.

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

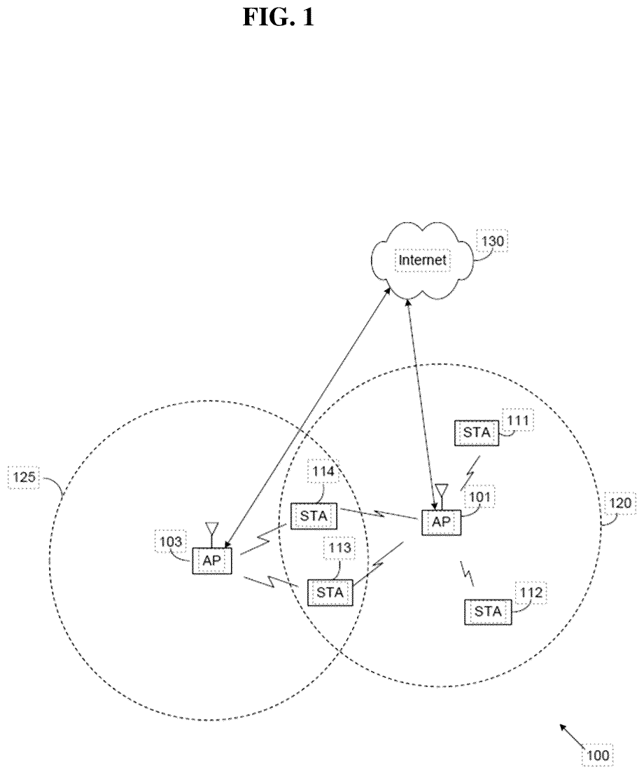

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs and variations in the radio environment associated with natural and man-made obstructions.

As described in more detail below, one or more of the APs may include circuitry and/or programming for management of multi-user MIMO (MU-MIMO) and orthogonal frequency division multiple access (OFDMA) channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

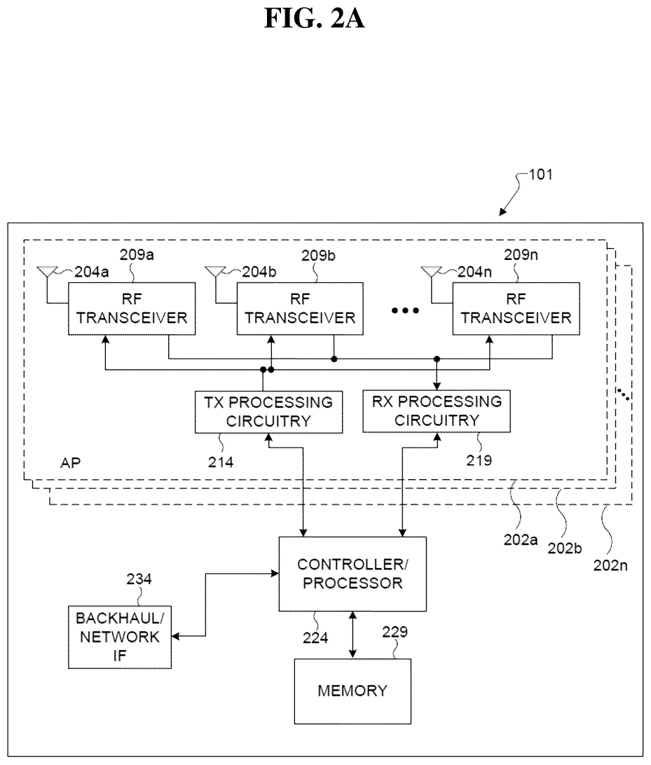

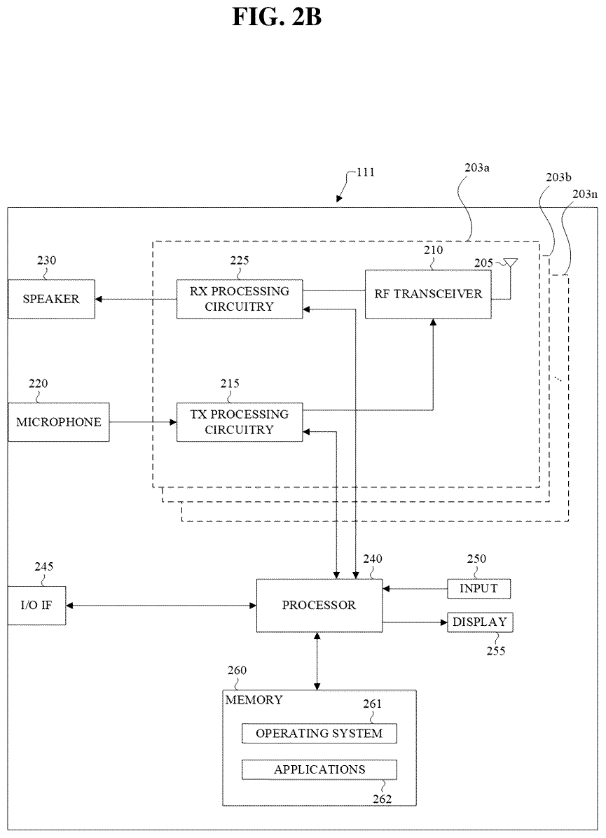

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementations of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

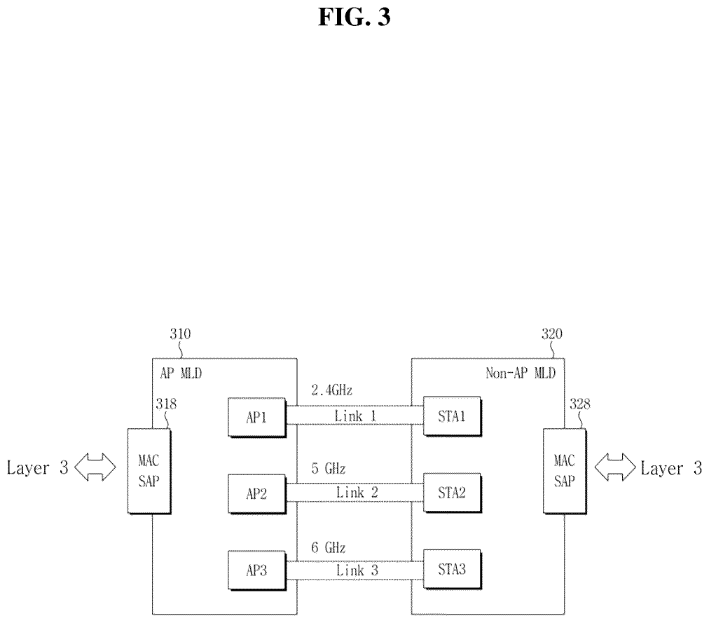

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” iii) IEEE P802.11be/D6.0, “Wireless LAN Medium Access Control (MAC) and Physical Layer (PHY) Specifications” and iv) IEEE P802.11 REVme Draft D6.0 “Wireless LAN Medium Access Control (MAC) and Physical Layer (PHY) Specifications.”

Next generation WLAN system is designed to provide better support for low-latency applications. Today it is not uncommon to observe numerous devices operating on the same network. Many of such devices may be latency-tolerant but still contend with the devices with low-latency applications for the same time and frequency resources. In some cases, the AP as the network controller may not have enough control over the unregulated/unmanaged traffic that contends with the low-latency traffic within the infrastructure basic service set (BSS) of STAs served by the AP. Some of the unmanaged traffic that interfere with the AP's BSS' latency sensitive traffic may be coming from uplink (UL)/downlink (DL) or direct link communications within the infrastructure BSS that the AP manages; others may be due to transmission in the neighboring infrastructure BSS (OBSS); yet others may be coming from neighboring independent BSS or peer-to-peer (P2P) networks. It is advantageous for the next generation WLAN system to have mechanisms to better handle the unmanaged traffic to prioritize the low-latency traffic in the network.

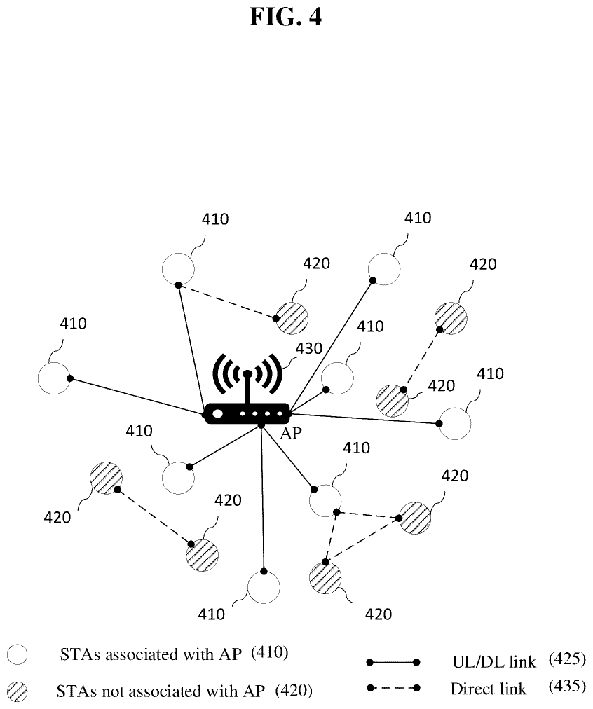

FIG. 4 shows a network where infrastructure traffic and non-infrastructure traffic coexist in accordance with one embodiment. An infrastructure BSS may include an AP 430 managing STAs 410 (also referred to as STAs 410 associated with AP 430). AP 430 and STAs 410 may communicate through uplinks/downlink channels (UL/DL) 425. FIG. 4 also shows STAs 420 that are not associated with AP 430, such as those in a neighboring BSS (OBSS) or from neighboring independent BSS. STAs 410 and STAs 420 may communicate with each other directly using a direct link 435 (P2P communication) without routing the traffic going through AP 430. The UL/DL 425 and direct links 435 may include traffic for low-latency applications and latency-tolerant traffic sharing the wireless communication medium.

A first STA may indicate to its associated AP a sequence of time periods during which the first STA will be unavailable for frame exchanges with the AP. During the unavailability with the AP, the first STA may be involved in P2P communication with a second STA.

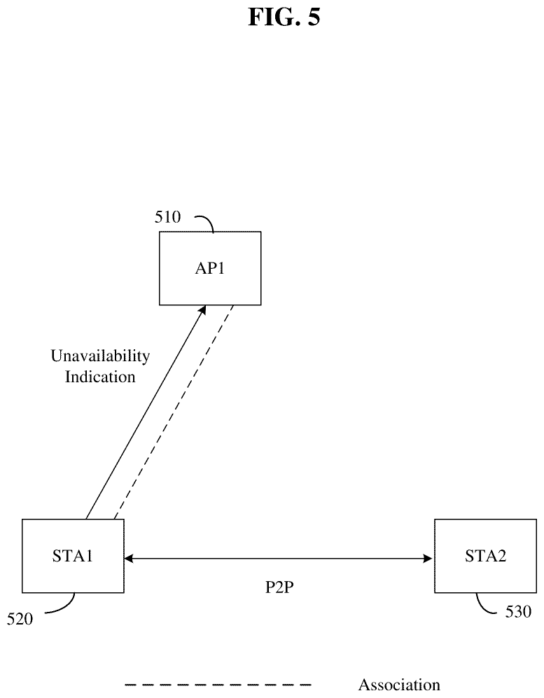

FIG. 5 shows a STA1 520 indicating to its associated AP 510 time periods during which STA1 520 will be unavailable for frame exchange with AP 510 due to scheduled P2P communication with STA2 530 in accordance with one embodiment.

In one embodiment, the first STA may also be unavailable due to a scheduled coexistence (coex) event, for example, with a second STA.

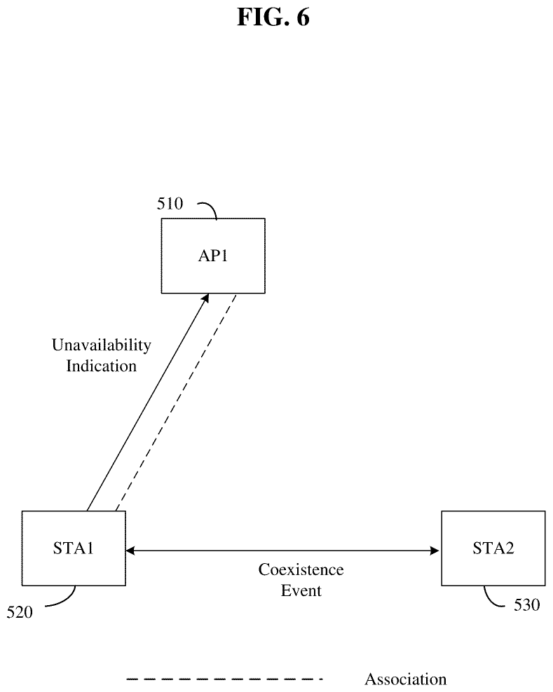

FIG. 6 shows a STA1 520 indicating to its associated AP1 510 time periods during which STA1 520 will be unavailable for frame exchange with AP1 510 due to a scheduled P2P coex event with STA2 530 in accordance with one embodiment.

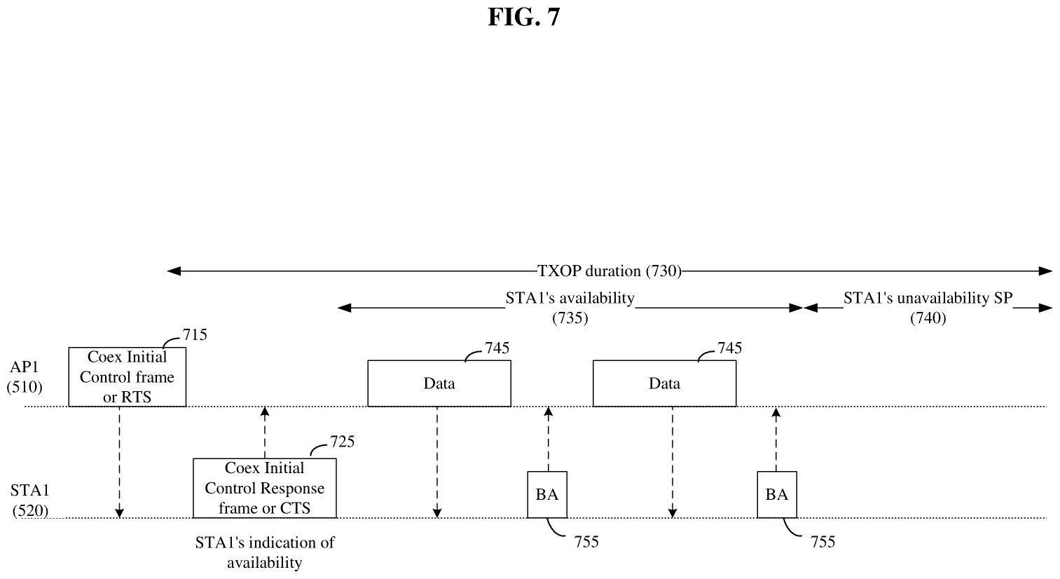

FIG. 7 shows a STA1 520 setting up an availability/unavailability schedule with its associated AP1 510 due to an upcoming coex event in one scenario. AP1 510 may transmit an initial control frame 715 for coex events (or a request-to-send (RTS) frame) to STA1 520 to solicit a response on the availability/unavailability schedule of STA1 520. STA1 520 may transmit an initial control response frame 725 (or a clear-to-send (CTS) frame) to indicate when STA1 520 will be unavailable for communication with AP1 510.

The initial control frame 715 for coex events (or RTS) may set up a transmit opportunity (TXOP) 730 for AP1 510 and STA1 520 to communicate. STA1 520 may respond by transmitting the initial control response frame 725 (or CTS) to indicate an unavailability service period (SP) 740 during which STA1 520 will be unavailable for communication with AP1 510 due to an upcoming coex event. FIG. 7 shows an initial availability interval 735 followed by unavailability SP 740 within TXOP 730. During initial availability interval 735, AP1 510 and STA1 520 may exchange frames. For example, AP1 510 may transmit a sequence of data frames 745 to STA1 520. STA1 520 may acknowledge receipt of the sequence of data frames 745 by transmitting a sequence of a block acknowledge (BA) frames 755 to AP1 510. Subsequently, during the unavailability SP 740, STA1 520 is unavailable to communicate with AP1 510 due to the coex event.

In one scenario, after setting up the unavailability schedule, AP1 510 may want STA1 520 to remain available in spite of the coex event. However, in the above-mentioned scenario, there is no mechanism for AP1 510 to inform or recommend STA1 520 to change the unavailability SP 740. For example, AP1 510 may want to send high-priority traffic to STA1 520 during the frame exchange sequence, but because of the unavailability of STA1 520 during the unavailability SP 740, STA1 520 may be deprived of the high-priority traffic. As a result, latency-sensitivity applications running on STA1 520 may suffer.

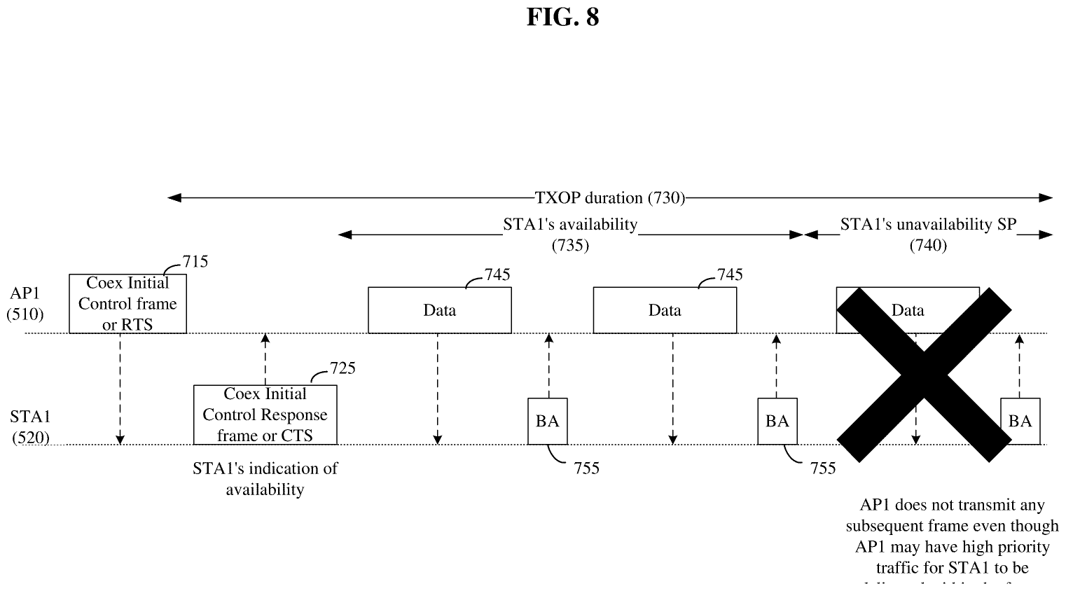

FIG. 8 shows STA1 520 missing high-priority traffic from AP1 520 due to unavailability (coex event) of STA1 520. AP1 510 and STA1 520 may exchange frames during the availability interval 735. During the unavailability SP 740, AP1 510 does not transmit any subsequent frame even though AP1 510 may have high-priority traffic to deliver to STA1 520 within the frame exchange sequence.

Disclosed herein is a mechanism and framework for an AP to request for information related to an unavailability schedule or peer-to-peer target wake time (P2P TWT) schedule that has been set up with a STA. The information may enable the AP to request changes to the parameters of the unavailability schedule or P2P TWT schedule. According to one embodiment, for the scenario where a first STA associated with an AP intends to inform the AP about its unavailability for communication with the AP, for example due to an upcoming coex event in which the first STA might be involved, the first STA may inform the AP about the nature of the coex event.

For example, in one embodiment of the scenario where a first STA associated with an AP intends to inform the AP about its unavailability for communication with the AP, for example due to an upcoming coex event in which the first STA might be involved, if the first STA sends a message to the AP informing the AP about the impending unavailability, that message or any related subsequent message may also contain information on whether the coex is for Bluetooth, UWB, LTE, Wi-Fi (P2P), or other technology. For example, the first STA may inform the AP that the coex event is due to Bluetooth, how long this Bluetooth related coex event will happen, and the time instance when this coex event will start and end, etc.

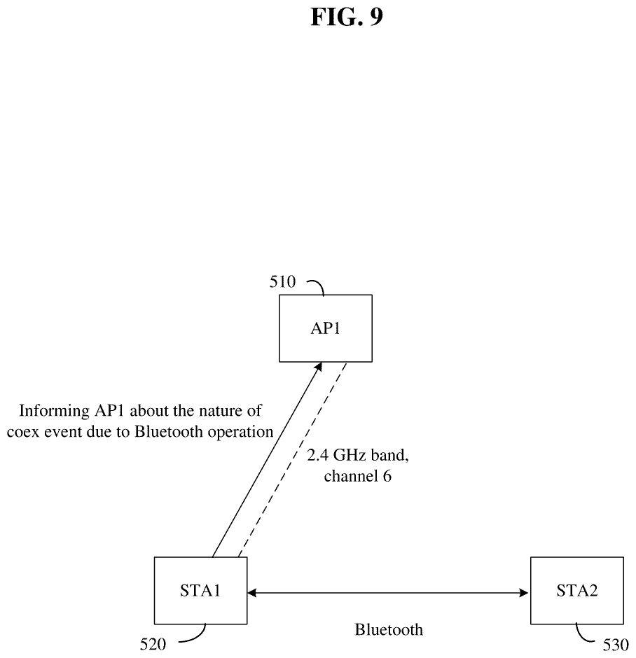

FIG. 9 shows a STA1 520 indicating to its associated AP 510 the nature of the coex event due to a Bluetooth-related operation in accordance with one embodiment. For example, STA1 520 may transmit a message on a band/channel (2.4 GHz band, channel 6) to indicate to AP1 510 about the impending unavailability due to a Bluetooth-related coex event with STA2 530. The message may contain information on the nature of the Bluetooth-related coex event.

According to one embodiment, a first STA associated with a first AP may inform the first AP about its unavailability for communication with the first AP, for example due to an upcoming coex event in which the first STA might be involved, and the coex event is for Wi-Fi communication with a second STA that is not the first AP. If the first STA sends a message to the first AP informing the first AP about the impending unavailability, that message or any related subsequent message may also contain information on whether the Wi-Fi communication is for P2P communication with a second STA, and if it is for P2P communication with a second STA, whether the P2P communication is expected to happen on the same band and/or channel where the first AP is operating or on a different band/channel.

According to one embodiment, the first STA may inform the AP about the band and channel where the Wi-Fi P2P communication is expected to happen, for how long this Wi-Fi P2P communication is expected to happen, and time instance when this coex event due to the Wi-Fi P2P communication will take place, etc.

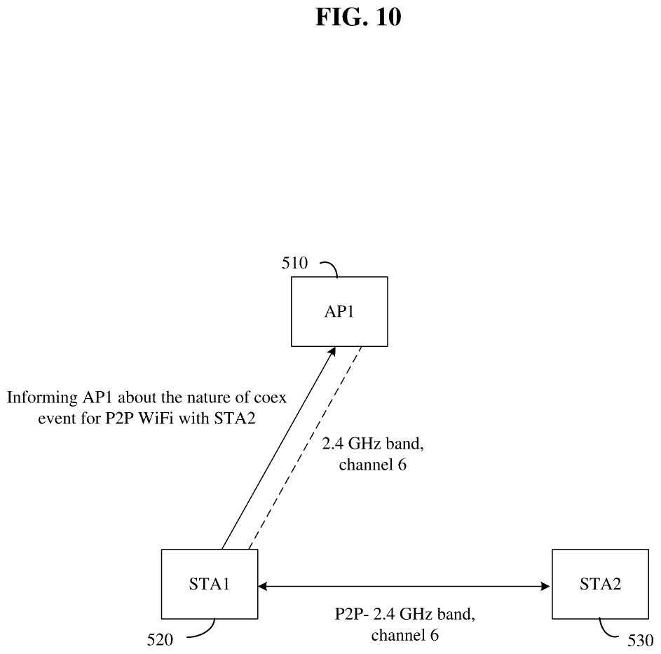

FIG. 10 shows a STA1 520 indicating to its associated AP 510 the nature of the coex event due to a P2P Wi-Fi coex event when the P2P communication is expected to happen on the same band/channel as the communication between STA1 520 and AP 510 in accordance with one embodiment.

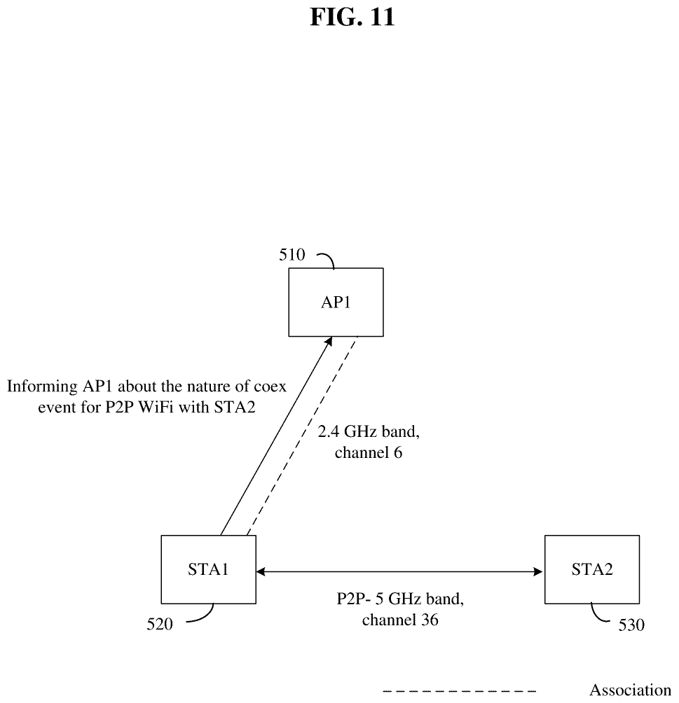

FIG. 11 shows a STA1 520 indicating to its associated AP 510 the nature of the coex event due to a P2P Wi-Fi coex event when the P2P communication is expected to happen on a different band/channel from those used between STA1 520 and AP 510 in accordance with one embodiment.

According to one embodiment, the first STA may send a message to the first AP informing the first AP about its impending unavailability due to a coex event, and that message or any related subsequent message may also contain information on whether the coex event is for Wi-Fi P2P communication with a second STA that is not the first AP, and if it is for Wi-Fi P2P communication with a second STA, what the traffic characteristics are for the Wi-Fi P2P communication.

According to one embodiment, the traffic characteristics may include:
The traffic identifier (TID value) of the traffic that is to be delivered for the P2P communication with a second STA;
The user priority (UP) of the traffic that is to be delivered for the P2P communication with a second STA;
The delay bound of the traffic that is to be delivered for the P2P communication with a second STA;
The minimum service interval of the traffic that is to be delivered for the P2P communication with a second STA;
The maximum service interval of the traffic that is to be delivered for the P2P communication with a second STA;
Service period of the traffic that is to be delivered for the P2P communication with a second STA;
Service interval or SP interval of the traffic that is to be delivered for the P2P communication with a second STA;
The identifier of the second STA, for example the association identifier (AID) or media access control (MAC) address value of the second STA.

According to one embodiment, when the first STA sends a message to the first AP informing the first AP about the impending unavailability due to a coex event, the first AP may respond to the first STA by soliciting more information about the nature of the coex event for which the first STA has made unavailability indication.

According to one embodiment, in response to the message from the first STA about the impending unavailability of the first STA due to the coex event, the first AP may send a Coex Information Request frame to the first STA to solicit more information about the nature of the coex event for which the first STA has made unavailability indication. The Coex Information Request frame may solicit information on the traffic of the coex event.

According to one embodiment, the information on the traffic of the coex event solicited by the first AP using the Coex Information Request frame may include:
The traffic identifier (TID value) of the traffic that is to be delivered for the P2P communication with a second STA;
The user priority (UP) of the traffic that is to be delivered for the P2P communication with a second STA;
The delay bound of the traffic that is to be delivered for the P2P communication with a second STA;
The minimum service interval of the traffic that is to be delivered for the P2P communication with a second STA;
The maximum service interval of the traffic that is to be delivered for the P2P communication with a second STA;
Service period of the traffic that is to be delivered for the P2P communication with a second STA;
Service interval or SP interval of the traffic that is to be delivered for the P2P communication with a second STA;
The identifier of the second STA, for example AID or MAC address value of the second STA.

According to one embodiment, in response to the Coex Information Request frame soliciting more information about the nature of the coex event for which the first STA has made unavailability indication, the first STA may send a Coex Information Response frame to the first AP. The Coex Information Response frame may contain the information requested by the first AP. Such information may include:
The traffic identifier (TID value) of the traffic that is to be delivered for the P2P communication with a second STA;
The user priority (UP) of the traffic that is to be delivered for the P2P communication with a second STA;
The delay bound of the traffic that is to be delivered for the P2P communication with a second STA;
The minimum service interval of the traffic that is to be delivered for the P2P communication with a second STA;
The maximum service interval of the traffic that is to be delivered for the P2P communication with a second STA;
Service period of the traffic that is to be delivered for the P2P communication with a second STA;
Service interval or SP interval of the traffic that is to be delivered for the P2P communication with a second STA;
The identifier of the second STA, for example AID or MAC address value of the second STA.

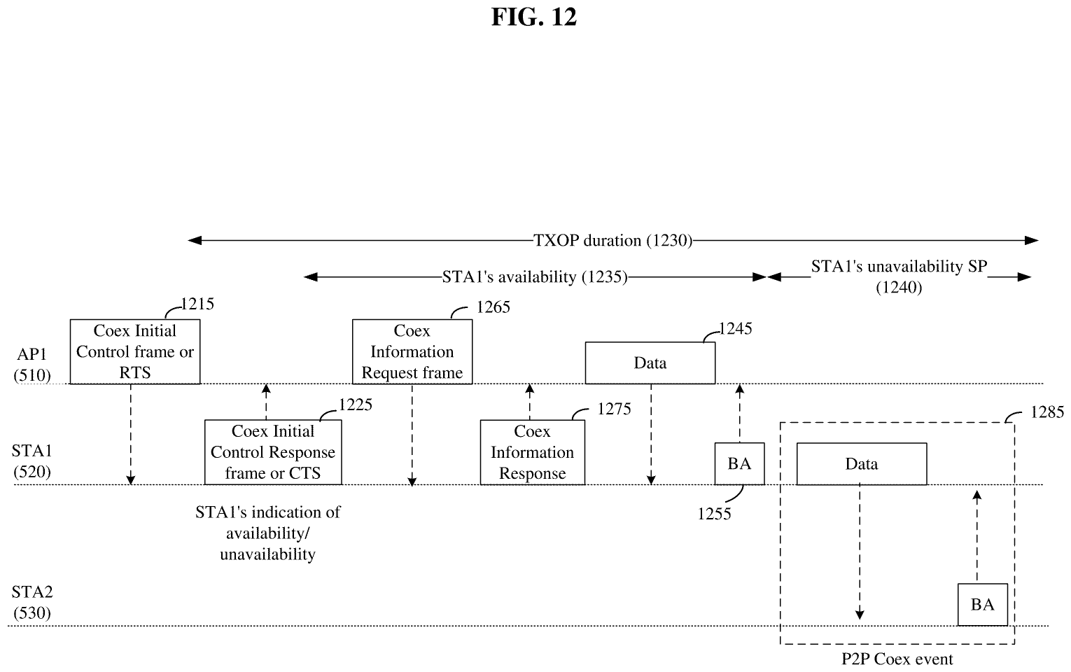

FIG. 12 shows a STA1 520 sharing information of a coex event with an AP1 510 using the Coex Information Request and Coex Information Response frame exchange in accordance with one embodiment. AP1 510 may transmit an initial control frame 1215 for coex events (or a RTS frame) to STA1 520 to solicit a response on the availability/unavailability schedule of STA1 520. STA1 520 may transmit an initial control response frame 1225 (or a CTS frame) to indicate when STA1 520 will be unavailable for communication with AP1 510.

The initial control frame 1215 for coex events (or RTS) may set up a TXOP 1230 for AP1 510 and STA1 520 to communicate. The initial control response frame 1225 (or CTS) may indicate an unavailability SP 1240 during which STA1 520 will be unavailable for communication with AP1 510 due to an upcoming coex event. FIG. 12 shows an initial availability interval 1235 followed by unavailability SP 1240 within TXOP 1230.

During initial availability interval 1235, AP1 510 may send a Coex Information Request frame 1265 to STA1 520 to solicit more information about the nature of the coex event. In response, STA1 520 may send a Coex Information Response frame 1275 to the AP1 510. The Coex Information Response frame 1275 may contain the information requested by AP1 510. For example, the Coex Information Request frame 1275 may indicate that the coex event is for P2P communication between STA1 520 and STA2 530 and may provide information on the nature of the traffic for the P2P communication. AP1 510 and STA1 520 may also exchange other types of frames during availability interval 1235. For example, AP1 510 may transmit a data frame 1245 to STA1 520. STA1 520 may acknowledge receipt of the data frame 1245 by transmitting a BA frame 1255 to AP1 510. During the unavailability SP 1240, STA1 520 and STA2 530 may exchange frames in a P2P coex event 1285. The characteristics of the traffic for P2P coex event 1285 may be in accordance with the information provided through the Coex Information Response frame 1275.

According to one embodiment, when the first STA sends a message to the first AP informing the first AP about the impending unavailability due to a coex event, the first AP may send a Coex Information element to the first STA to solicit more information about the nature of the coex event for which the first STA has made unavailability indication. The Coex Information element may be included in an initial control frame or RTS frame transmitted by the AP to the first STA, where the initial control frame or RTS may initiate a frame exchange sequence between the first AP and the first STA. The Coex Information clement may solicit information on the traffic. The information on the traffic of the coex event solicited by the first AP using the Coex Information element in the initial control frame or RTS frame may include:
The traffic identifier (TID value) of the traffic that is to be delivered for the P2P communication with a second STA;
The user priority (UP) of the traffic that is to be delivered for the P2P communication with a second STA;
The delay bound of the traffic that is to be delivered for the P2P communication with a second STA;
The minimum service interval of the traffic that is to be delivered for the P2P communication with a second STA;
The maximum service interval of the traffic that is to be delivered for the P2P communication with a second STA;
Service period of the traffic that is to be delivered for the P2P communication with a second STA;
Service interval or SP interval of the traffic that is to be delivered for the P2P communication with a second STA;
The identifier of the second STA, for example AID or MAC address value of the second STA.

According to one embodiment, in response to the Coex Information element in the initial control frame or RTS frame soliciting more information about the nature of the coex event for which the first STA has made unavailability indication, the first STA may send a Coex Information element included in an initial control response frame or CTS frame to the first AP. The Coex Information element in the initial control response frame or CTS frame may contain the information requested by the first AP. Such information may include:
The traffic identifier (TID value) of the traffic that is to be delivered for the P2P communication with a second STA;
The user priority (UP) of the traffic that is to be delivered for the P2P communication with a second STA;
The delay bound of the traffic that is to be delivered for the P2P communication with a second STA;
The minimum service interval of the traffic that is to be delivered for the P2P communication with a second STA;
The maximum service interval of the traffic that is to be delivered for the P2P communication with a second STA;
Service period of the traffic that is to be delivered for the P2P communication with a second STA;
Service interval or SP interval of the traffic that is to be delivered for the P2P communication with a second STA;
The identifier of the second STA, for example AID or MAC address value of the second STA.

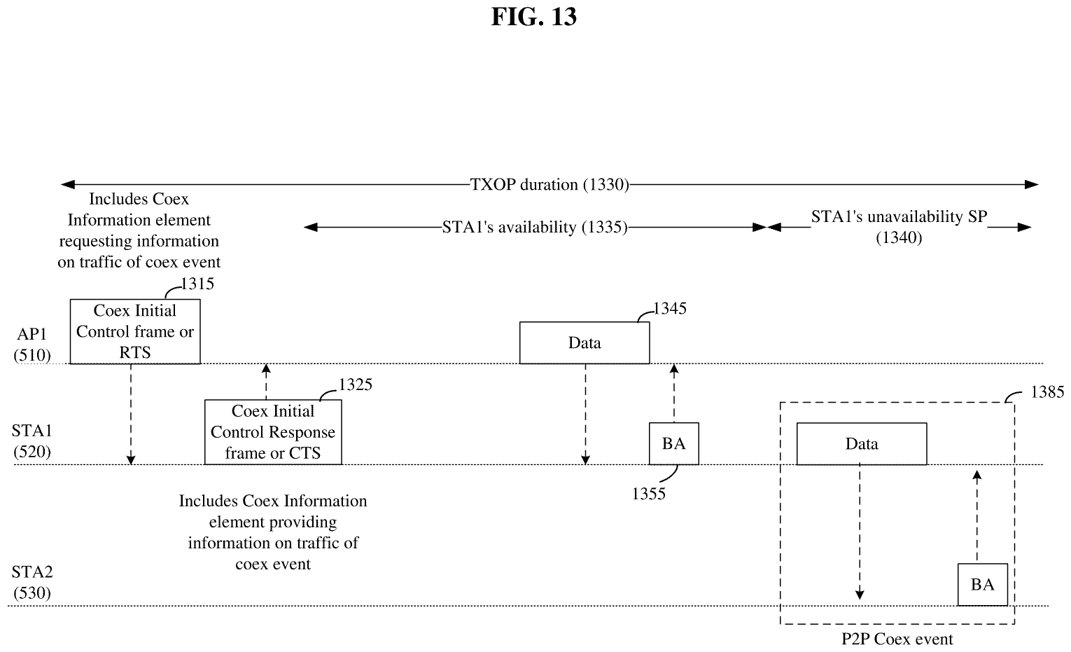

FIG. 13 shows a STA1 520 sharing information of a coex event with an AP1 510 using the initial control and initial response frame exchange in accordance with one embodiment. AP1 510 may transmit an initial control frame 1315 for coex events (or a RTS frame) to STA1 520 to solicit more information about the nature of the coex event for which the first STA has made an unavailability indication. The initial control frame 1315 (or a RTS frame) may include a Coex Information element requesting information on the traffic of the coex event.

In response, STA1 520 may send an initial control response frame 1325 to the AP1 510. The initial control response frame 1325 may include a Coex Information element providing the information requested by AP1 510. For example, the Coex Information element may indicate that the coex event is for P2P communication between STA1 520 and STA2 530 and may provide information on the nature of the traffic for the P2P communication.

The initial control frame 1315 for coex events (or RTS) may set up a TXOP 1330 for AP1 510 and STA1 520 to communicate. FIG. 13 shows an initial availability interval 1335 followed by unavailability SP 1340 within TXOP 1330. During initial availability interval 1335, AP1 510 and STA1 520 may exchange frames. For example, AP1 510 may transmit a data frame 1345 to STA1 520. STA1 520 may acknowledge receipt of the data frame 1345 by transmitting a BA frame 1355 to AP1 510. During the unavailability SP 1240, STA1 520 and STA2 530 may exchange frames in a P2P coex event 1385. The characteristics of the traffic for P2P coex event 1385 may be in accordance with the information provided through the Coex Information element included in the initial control response frame 1325 or CTS frame.

In one embodiment, a possible format of the Coex Information Request frame is shown in Table I.

TABLE I
A possible format of the Coex Information Request frame

| Order | Information |
|---|---|
| 1 | Category |
| 2 | Unprotected S1G Action |
| 3 | Dialog Token |
| 4 | WNM Action |
| 5 | Channel Usage Elements |
| 6 | Supported Operating Classes Element |
| 7 | TWT Elements |
| 8 | Timeout Interval Element |
| 9 | HT Capabilities Element |
| 10 | VHT Capabilities Element |
| 11 | HE Capabilities Element |
| 12 | HE 6 GHz Capabilities Element |
| 13 | EHT Capabilities Element |
| 14 | Coex Information Element |

In one embodiment. a possible format of the Coex Information Response frame is shown in Table II.

TABLE II
A possible format of the Coex Information Response frame

| Order | Information |
|---|---|
| 1 | Category |
| 2 | Unprotected S1G Action |
| 3 | Dialog Token |
| 4 | WNM Action |
| 5 | Channel Usage Elements |
| 6 | Supported Operating Classes Element |
| 7 | TWT Elements |
| 8 | Timeout Interval Element |
| 9 | HT Capabilities Element |
| 10 | VHT Capabilities Element |
| 11 | HE Capabilities Element |
| 12 | HE 6 GHz Capabilities Element |
| 13 | EHT Capabilities Element |
| 14 | Coex Information Element |

According to one embodiment, after receiving the information on the nature of the traffic for the coex event for which the first STA has indicated unavailability to the first AP, the first AP may recommend the first STA not to be unavailable, or alternatively the first AP may permit the first STA to become unavailable to the first AP for handling coex event. For example, the first AP may recommend the first STA not to be unavailable when the first AP may want to send high-priority traffic to the first STA during a period that may overlap with the unavailability SP of the coex event. In one embodiment, the first AP may suggest to the first STA to make changes to the parameters of the coex event.

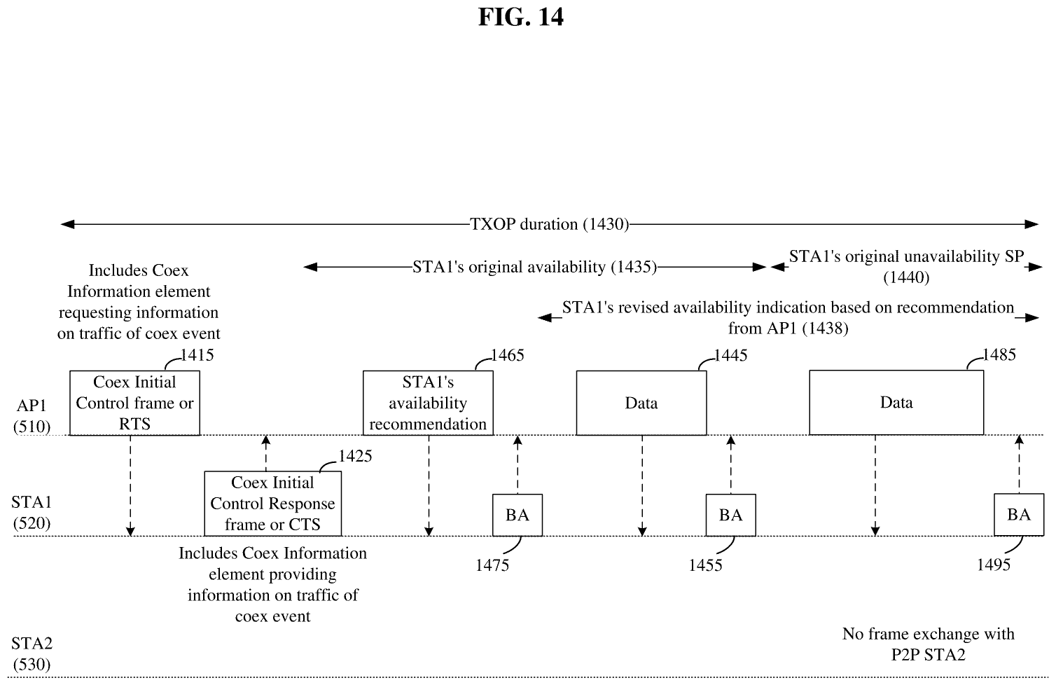

FIG. 14 shows an AP1 510 recommending to a STA1 520 to revise the timing of the unavailability SP in accordance with one embodiment. AP1 510 may transmit an initial control frame 1415 for coex events (or a RTS frame) to STA1 520 to solicit more information about the nature of the coex event for which the first STA has made an unavailability indication. The initial control frame 1415 (or a RTS frame) may include a Coex Information element requesting information on the traffic of the coex event.

In response, STA1 520 may send an initial control response frame 1425 to the AP1 510. The initial control response frame 1425 may include a Coex Information element providing the information requested by AP1 510. For example, the Coex Information element may indicate that the coex event is for P2P communication between STA1 520 and STA2 530 and may provide information on the nature of the traffic for the P2P communication.

The information on the nature of the traffic for the P2P communication may indicate an original unavailability SP 1440 during which STA1 520 is expected to perform P2P communication with STA2 530. However, AP1 510 may want STA1 520 to change original unavailability SP 1440 so that STA1 520 remains available longer than an original availability interval 1435 of TXOP duration 1430 based on original unavailability SP 1440.

AP1 510 may send an availability recommendation frame 1465 to STA1 520 to recommend STA1 520 to remain available longer for communicating with AP 510. STA1 520 may send a BA frame 1475 back to AP1 520 to acknowledge the recommendation. In response to the recommendation, STA1 520 may revise original unavailability SP 1440 so that original availability interval 1435 is extended to revised availability indication 1438. Based on the revised availability indication 1438, AP1 510 may then exchange frames with STA1 520, such as AP1 510 sending a data frame 1485 to STA1 520 and STA1 520 sending a BA frame 1495 back to AP1 510. As a result, there is no P2P frame exchange with STA2 530 during this time. FIG. 14 shows that during original availability interval 1435, AP 510 may also send a data frame 1465 to STA1 520 and STA1 520 may send a BA frame 1475 back to AP1 510.

In one embodiment, after receiving the information on the nature of the traffic for the coex event for which the first STA has indicated unavailability to the first AP, the first AP may issue a warning to the first STA. The warning may alert the first STA that QoS may not be satisfied if the unavailability SP or the characteristics of the coex event is not revised. In one embodiment, the warning may include an indication that the first AP has traffic to transmit and if the first STA does not change the unavailability SP or the characteristics of the coex event, the first STA may not be able to receive the traffic.

In reference to the various embodiments disclosed, the first STA can either be a TXOP responder or TXOP holder. Also, in references to the various embodiments disclosed, the first AP can either be a TXOP responder or TXOP holder.

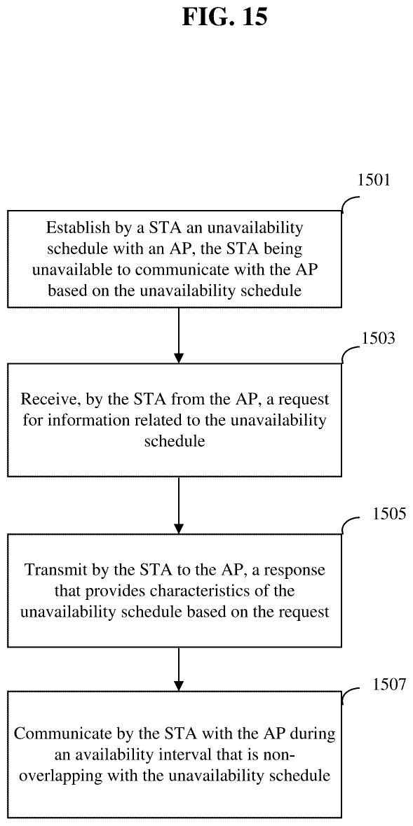

FIG. 15 shows a flow diagram of a method 1500 of a STA sharing information on an unavailability schedule with an AP in accordance with one embodiment. In one aspect, method 1500 may be performed by an initiator such as STA1 520 of FIG. 5 utilizing hardware, software, or combinations of hardware and software.

In operation 1501, the STA establishes an unavailability schedule with an AP associated with the STA. The unavailability schedule may include one or more unavailability SPs during which the STA will be unavailable for frame exchange with the AP due to scheduled P2P communication with a second STA.

In operation 1503, the STA receives from the AP a request for information related to the unavailability schedule. In one embodiment, the unavailability schedule is due to a coex event for P2P communication between the STA and a second STA. In one embodiment, the STA may receive from the AP a coexistence information request frame that solicits information on the traffic of the coex event.

In operation 1505, the STA transmits to the AP a response that provides characteristics of the unavailability schedule based on the request. In one embodiment, the STA may transmit to the AP a coexistence information response frame that provides information on the traffic of the coex event. In one embodiment, the information on the traffic of the coex event may include one or more of: a traffic identifier of the traffic for the P2P communication; a user priority of the traffic for the P2P communication; a delay bound of the traffic for the P2P communication; a minimum service interval of the traffic for the P2P communication; a maximum service interval of the traffic for the P2P communication; a service period of the traffic for the P2P communication; a service interval of the traffic for the P2P communication; or an identifier of the second station.

In operation 1507, the STA communicates with the AP during an availability interval that is non-overlapping with the unavailability schedule.

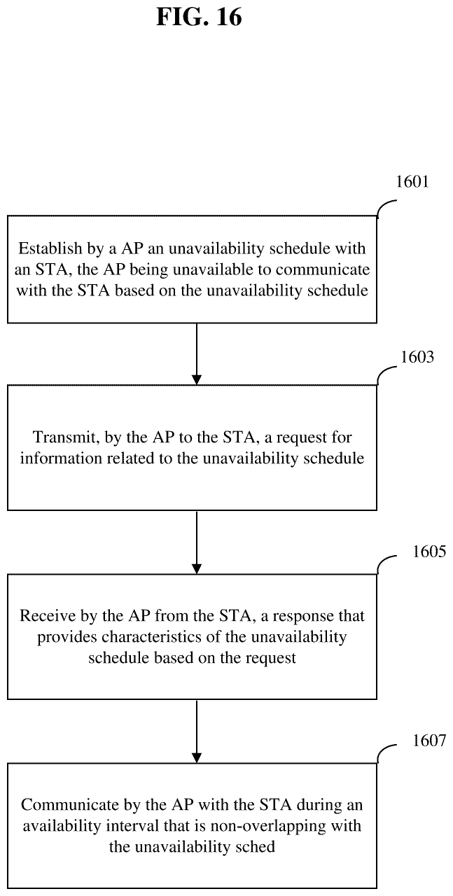

FIG. 16 shows a flow diagram of a method 1600 of an AP receiving information on an unavailability schedule from a STA in accordance with one embodiment. In one aspect, method 1600 may be performed by an initiator such as AP1 510 of FIG. 5 utilizing hardware, software, or combinations of hardware and software.

In operation 1601, the AP establishes an unavailability schedule with a STA. The unavailability schedule may include one or more unavailability SPs during which the STA will be unavailable for frame exchange with the AP due to scheduled P2P communication with a second STA.

In operation 1603, the AP transmits to the STA a request for information related to the unavailability schedule. In one embodiment, the unavailability schedule is due to a coex event for P2P communication between the STA and a second STA. In one embodiment, the AP may transmit to the STA a coexistence information request frame that solicits information on the traffic of the coex event.

In operation 1605, the AP receives from the STA a response that provides characteristics of the unavailability schedule based on the request. In one embodiment, the AP may receive from the STA a coexistence information response frame that provides information on the traffic of the coex event. In one embodiment, the information on the traffic of the coex event may include one or more of: a traffic identifier of the traffic for the P2P communication; a user priority of the traffic for the P2P communication; a delay bound of the traffic for the P2P communication; a minimum service interval of the traffic for the P2P communication; a maximum service interval of the traffic for the P2P communication; a service period of the traffic for the P2P communication; a service interval of the traffic for the P2P communication; or an identifier of the second station.

In operation 1607, the AP communicates with the STA during an availability interval that is non-overlapping with the unavailability schedule.

The disclosure presents various embodiments of a STA sharing with an AP information on the unavailability schedule due to P2P coex events. The disclosed techniques enable the next generation WLAN system to have mechanisms to better handle traffic to prioritize the low-latency traffic in the network.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law. nor should they be interpreted in such a way.

What is claimed is:

1. A first station (STA) in a wireless network, comprising:
a memory; and
a processor coupled to the memory, the processor configured to cause:
establishing an unavailability schedule with an access point (AP), the first STA being unavailable to communicate with the AP based on the unavailability schedule;
receiving, from the AP, a request for information related to the unavailability schedule;
transmitting, to the AP, a response that provides characteristics of the unavailability schedule based on the request; and
communicating with the AP during an availability interval that is non-overlapping with the unavailability schedule.

2. The first STA of claim 1, wherein the unavailability schedule is due to a coexistence event for peer-to-peer (P2P) communication between the first STA and a second STA, and wherein the receiving the request for information related to the unavailability schedule comprises:
receiving, from the AP, a coexistence information request frame that solicits information on traffic of the coexistence event.

3. The first STA of claim 2, wherein the information on the traffic of the coexistence event comprises one or more of:
a traffic identifier of the traffic for the P2P communication;
a user priority of the traffic for the P2P communication;
a delay bound of the traffic for the P2P communication;
a minimum service interval of the traffic for the P2P communication;
a maximum service interval of the traffic for the P2P communication;
a service period of the traffic for the P2P communication;
a service interval of the traffic for the P2P communication; or
an identifier of the second STA.

4. The first STA of claim 1, wherein the unavailability schedule is due to a coexistence event for peer-to-peer (P2P) communication between the first STA and a second STA, and wherein the transmitting the response that provides characteristics of the unavailability schedule comprises:
transmitting, to the AP, a coexistence information response frame that provides information on traffic of the coexistence event.

5. The first STA of claim 4, wherein the information on traffic of the coexistence event comprises one or more of:
a traffic identifier of the traffic for the P2P communication;
a user priority of the traffic for the P2P communication;
a delay bound of the traffic for the P2P communication;
a minimum service interval of the traffic for the P2P communication;
a maximum service interval of the traffic for the P2P communication;
a service period of the traffic for the P2P communication;
a service interval of the traffic for the P2P communication; or
an identifier of the second STA.

6. The first STA of claim 1, wherein the unavailability schedule is due to a coexistence event for peer-to-peer (P2P) communication between the first STA and a second STA, and wherein the receiving the request for information related to the unavailability schedule comprises:
receiving, from the AP, an initial control frame that solicits information on traffic of the coexistence event, wherein the initial control frame initiates a frame exchange sequence between the first STA and the AP.

7. The first STA of claim 6, wherein the transmitting the response that provides characteristics of the unavailability schedule comprises:
transmitting, to the AP, an initial control response frame that provides information on the traffic for the P2P communication of the coexistence event in response to the initial control frame.

8. The first STA of claim 1, wherein the processor is further configured to cause:
receiving, from the AP, a recommendation frame that recommends a change to the unavailability schedule; and
modifying the unavailability schedule based on the recommendation frame.

9. The first STA of claim 1, wherein the unavailability schedule is due to a coexistence event for peer-to-peer (P2P) communication between the first STA and a second STA, and wherein the characteristics of the unavailability schedule provided by the response comprise one or more of:
a frequency band for the P2P communication;
a frequency channel for the P2P communication;
a length of the P2P communication; or
a time of the P2P communication.

10. An access point (AP) in a wireless network, comprising:
a memory; and
a processor coupled to the memory, the processor configured to cause:
establishing an unavailability schedule with a first station (STA), the AP being unavailable to communicate with the first STA based on the unavailability schedule;
transmitting, to the first STA, a request for information related to the unavailability schedule;
receiving, from the first STA, a response that provides characteristics of the unavailability schedule based on the request; and
communicating with the first STA during an availability interval that is non-overlapping with the unavailability schedule.

11. The AP of claim 10, wherein the unavailability schedule is due to a coexistence event for peer-to-peer (P2P) communication between the first STA and a second STA, and wherein the transmitting the request for information related to the unavailability schedule comprises:
transmitting, to the first STA, a coexistence information request frame that solicits information on traffic of the coexistence event.

12. The AP of claim 11, wherein the information on the traffic of the coexistence event comprises one or more of:
a traffic identifier of the traffic for the P2P communication;
a user priority of the traffic for the P2P communication;
a delay bound of the traffic for the P2P communication;
a minimum service interval of the traffic for the P2P communication;
a maximum service interval of the traffic for the P2P communication;
a service period of the traffic for the P2P communication;
a service interval of the traffic for the P2P communication; or
an identifier of the second STA.

13. The AP of claim 10, wherein the unavailability schedule is due to a coexistence event for peer-to-peer (P2P) communication between the first STA and a second STA, and wherein the receiving the response that provides characteristics of the unavailability schedule comprises:
receiving, from the first STA, a coexistence information response frame that provides information on traffic of the coexistence event.

14. The AP of claim 13, wherein the information on traffic of the coexistence event comprises one or more of:
a traffic identifier of the traffic for the P2P communication;
a user priority of the traffic for the P2P communication;
a delay bound of the traffic for the P2P communication;
a minimum service interval of the traffic for the P2P communication;
a maximum service interval of the traffic for the P2P communication;
a service period of the traffic for the P2P communication;
a service interval of the traffic for the P2P communication; or
an identifier of the second STA.

15. The AP of claim 10, wherein the unavailability schedule is due to a coexistence event for peer-to-peer (P2P) communication between the first STA and a second STA, and wherein the transmitting the request for information related to the unavailability schedule comprises:
transmitting, to the first STA, an initial control frame that solicits information on traffic of the coexistence event, wherein the initial control frame initiates a frame exchange sequence between the first STA and the AP.

16. The AP of claim of claim 15, wherein the receiving the response that provides characteristics of the unavailability schedule comprises:
receiving, from the first STA, an initial control response frame that provides information on the traffic for the P2P communication of the coexistence event in response to the initial control frame.

17. The AP of claim 10, wherein the processor is further configured to cause:
transmitting, to the first STA, a recommendation frame that recommends a change to the unavailability schedule in response to the characteristics of the unavailability schedule received from the first STA.

18. The AP of claim 10, wherein the unavailability schedule is due to a coexistence event for peer-to-peer (P2P) communication between the first STA and a second STA, and wherein the characteristics of the unavailability schedule provided by the response comprise one or more of:
a frequency band for the P2P communication;
a frequency channel for the P2P communication;
a length of the P2P communication; or
a time of the P2P communication.

19. A method performed by a first station (STA) in a wireless network, comprising:
establishing an unavailability schedule with an access point (AP), the first STA being unavailable to communicate with the AP based on the unavailability schedule;
receiving, from the AP, a request for information related to the unavailability schedule;
transmitting, to the AP, a response that provides characteristics of the unavailability schedule based on the request; and
communicating with the AP during an availability interval that is non-overlapping with the unavailability schedule.

20. The method of claim 19, wherein the unavailability schedule is due to a coexistence event for peer-to-peer (P2P) communication between the first STA and a second STA, wherein receiving the request for information related to the unavailability schedule comprises:
receiving, from the AP, a coexistence information request frame that solicits information on traffic of the coexistence event,
wherein transmitting, to the AP, the response that provides characteristics of the unavailability schedule comprises:
transmitting, to the AP, a coexistence information response frame that provides the information on the traffic of the coexistence event,
and wherein the information on the traffic of the coexistence event comprises one or more of:
a traffic identifier of the traffic for the P2P communication;
a user priority of the traffic for the P2P communication;
a delay bound of the traffic for the P2P communication;
a minimum service interval of the traffic for the P2P communication;
a maximum service interval of the traffic for the P2P communication;
a service period of the traffic for the P2P communication;
a service interval of the traffic for the P2P communication; or
an identifier of the second STA.
